(19) United States
(12) Patent Application Publication
(10) Pub. No.: US 2008/0038571 A1
(43) Pub. Date: Feb. 14, 2008

(54) Stretch Film Having Low Coefficient of Friction on Outer Layers

(76) Inventors: Brooke KIitzmiller, North Canton, OH (US); John Cook, North Canton, OH (US)

Correspondence Address: MCANDREWS HELD & MALLOY, LTD, 500 WEST MADISON STREET, SUITE 3400, CHICAGO, IL, 60661, US

(21) Appl. No.: 11/575,536

(22) PCT Filed: Oct. 13, 2004
(86) PCT No.: PCT/US04/33662

§ 371 Date: Oct. 18, 2007

(51) Int. Cl. B32B 7/02; B32B 27/08; B32B 27/32

(52) U.S. Cl. 428/523

(57) ABSTRACT

Stretch wrap films are used to hold goods to pallets during storage and shipping. A multilayer stretch wrap film with at least one outer layer of a polypropylene and polystyrene mixture, and other layers of blends of polyethylenes. The film of the present invention optimizes physical properties enabling the film to exhibit superior abrasion resistance in order to protect wrapped contents from damage and exposure during shipment as well as good cling thereby eliminating the need for taping of the film in order to secure the contents.

### TECHNICAL FIELD

The present invention is directed to a multilayer stretch wrap film. More particularly, the present invention is directed to a stretch wrap film having at least one outer non-cling layer composed of a mixture of polypropylene and polystyrene, at least one core layer, and at least one cling layer.

### BACKGROUND ART

Stretch or “cling” films are films that self-seal when portions are overlapped. These films are typically multilayer films and may be used in applications where it is desirable to securely hold or wrap an article(s) such as when palletizing loads. For load palletization operations, the film is stretched tightly around articles placed on a pallet and then self-sealed while the film is still in the stretched condition to create a secure package. Stretch wrap film may have a non-cling surface and a cling surface opposite the non-cling surface. The non-cling surface generally does not cling to itself and prevents adjoining pallets from sticking to one another. The cling surface enables the film to stick to itself. The cling surface should have sufficient cling so that the film sticks to itself when wrapped around a pallet, does not unravel, and does not need taping in order to secure the film. Moreover, the film should exhibit superior abrasion resistance in order to protect wrapped contents from damage and exposure during shipment.

### DISCLOSURE OF THE INVENTION

The multilayer stretch film of the present invention includes at least one first layer composed of polypropylene and polystyrene. Further, the film of the present invention includes at least one second layer composed of at least one polyolefin polymer, and at least one third layer composed of a polymer selected from the group consisting of ultra low density polyethylene, very low density polyethylene, plastomer, polyisobutylene, linear low density polyethylene, and mixtures thereof.

### BEST MODE FOR CARRYING OUT OF THE INVENTION

The present invention relates to stretch films with an optimized balance of beneficial properties. In particular, the stretch film of the present invention has a low coefficient of friction on its outer layers and imparts superior abrasion resistance and cling properties suitable for stretch-wrapping applications. The stretch films of the present invention preferably have three or more layers including, but not limited to, a core layer, an outer or “skin” cling layer and an outer or “skin” non-cling layer. Embodiments of the inventive films with five or fewer layers maybe represented by the construction A/B/C/D/E. In this construction, A is a cling layer, E is a non-cling layer and B, C, and D may be the same or different polymer resins, selected to optimize certain features discussed of the core layer such as load containment, stretch, and puncture resistance while maintaining adequate tear propagation. An embodiment with seven layers may be represented by the construction A/B/C₁/C₂/C₃/D/E. Those skilled in the art will appreciate that various combinations are possible. For example, a preferred film may have five identical core layers, B/C₁/C₂/C₃/D. Alternatively, a seven layer film may have four core layers, B/C₁/C₂/C₃, and two adjoining non-cling layers, D/E, and a cling layer A.

The total thickness or gauge of the film may vary and depends on the intended application for the film. It will be appreciated by those skilled in the art that the thickness of each individual layer may be similar or different in addition to having similar or different compositions. The thickness of each layer is therefore independent and may vary within the parameters set by the total thickness of the film. For example, a film having the construction A/B/C/D/E may preferably have corresponding percentage by weight thicknesses of 10/15/45/10/20 of the total thickness of the film. The construction A/C/E may preferably have corresponding percentage thicknesses of 10/70/20. The construction A/B/C₁/C₂/C₃/D/E may preferably have corresponding thicknesses of 10/15/15/15/15/10/20.

The multilayer cast films of the present invention are typically manufactured by cast film or feed block coextrusion. Alternatively, the stretch films of the present invention may be made by blown film (tubular) coextrusion. Methods for cast film, feed block and blown film extrusion are disclosed in The Wiley Encyclopedia of packaging Technology, Aaron L. Brody et al. eds., 2nd Ed. 1997, pp. 233-38, which is incorporated herein by reference. Methods for film extrusion are also disclosed in U.S. Pat. No. 6,265,055 which is also incorporated herein by reference.

The cling layer of the film of the present invention enables the film to cling to itself when the film is wrapped on a load. The cling layer preferably constitutes from about 5% to about 40% by weight of the total thickness of the film, more preferably from about 5-15%, and most preferably about 10%. The cling layer preferably contains one or more of ultra low density polyethylene, very low density polyethylene, plastomer, polyisobutylene, linear low density polyethylene and mixtures or blends thereof.

The cling layer may preferably contain from about 0% to 100%, more preferably from about 10-40%, and most preferably about 20% by weight of an ultra low density polyethylene. Ultra low density polyethylene (hereinafter “ULDPE”) is sometimes also known as very low density polyethylene. ULDPE is ethylene copolymerized with at least one C₃-C₁₀ α-olefin, more preferably a C₈ α-olefin. The resulting ULDPE preferably has a density ranging from about 0.885 g/cm³ to about 0.920 g/cm³, more preferably from about 0.888 g/cm³ to about 0.910 g/cm³, and a melt index ranging from 1.0 g/10 min to 20 g/10 min, more preferably ranging from about 2 g/10 min to about 10 g/10 min. In a preferred embodiment, the cling layer contains about 85% of a ULDPE that is ethylene copolymerized with a C₈ α-olefin with a density of about 0.900 g/cm³, and a melt index of about 5.

ULDPE can be produced by a variety of processes, including gas phase, solution and slurry polymerization as disclosed in The Wiley Encyclopedia of Packaging Technology, Aaron L. Brody et al. eds., 2nd Ed. 1997, pp. 748-50. ULDPE is typically manufactured using a Ziegler-Natta catalyst, although a number of other catalysts maybe used. For example, ULDPE may be manufactured with a metallocene catalyst. Alternatively, ULDPE maybe manufactured with a catalyst that is a hybrid of a metallocene catalyst and a Ziegler-Natta catalyst. Methods for manufacturing ULDPE are also disclosed in U.S. Pat. No. 5,399,426, U.S. Pat. No. 4,668,752, U.S. Pat. No. 3,058,963, U.S. Pat. No. 2,905,645, U.S. Pat. No. 2,862,917, U.S. Pat. No. 2,699,457, which are incorporated by reference herein. The density of ULDPE is achieved by copolymerizing ethylene with a sufficient amount of one or more monomers. The monomers are preferably selected from 1-butene, 1-hexene, 4-methyl-1-pentene and 1-octene.

The cling layer may also include a plastomer in a range from 0% to about 100% by weight of the cling layer, more preferably from about 70-100%, and most preferably about 80%. The plastomer is preferably ethylene copolymerized with a C₃-C₁₀ α-olefin, having a density in the range from about 0.850 g/cm³ to about 0.900 g/cm³, more preferably of about 0.860 g/cm³ to about 0.880 g/cm³, and a melt index of about 1.0 g/10 min to about 20.0 g/10 min, more preferably from about 2.0 to about 10.0 g/10 min. The cling layer preferably contains about 70-100% plastomer with a density of about 0.875 g/cm³ and a melt index of about 3.0 g/10 min. The plastomer is manufactured by the same process described above with reference to ULDPE, except that a higher amount by weight of one or more monomers is copolymerized with ethylene. In a preferred embodiment, the plastomer is ethylene copolymerized with a C8 α-olefin, which has an unstretched cling of 250 g and a 200% stretched cling of 66 g as measured by ASTM D 4649. Cling is the strength required, in grams, to pull apart overlapping film along a test section.

The stretch film of the present invention has one or more core layers. The core layers or layer make up about 50% to about 90% by weight of the thickness of the film, more preferably from about 60-80%, and most preferably about 70% of the thickness of the film. Each core layer may preferably include a low density polyethylene in an amount ranging from about 0.01% to about 3% by weight of the core layer and a linear low density polyethylene (hereinafter “LLDPE”) in an amount ranging from about 97 to about 99.9% by weight of the core layer. More particularly, the core layer includes a low density polyethylene in an amount less than 3%.

The LDPE of the core layer may have a density ranging from about 0.900 g/cm³ to about 0.940 g/cm³, more preferably from about 0.920 g/cm³ to about 0.930 g/cm³ and a melt index ranging from about 0.10 g/10 min to about 10.0 g/10 min, more preferably from about 0.3 g/10 min to about 0.7 g/10 min. LDPE is generally used for heavy bags, such as ice bags or shipping sacks, which normally have a thickness from 1.5 mil to 4.0 mil. A mil is a unit of distance equivalent to 0.001 inch (25.4 microns).

The LDPE may be ethylene homopolymer or ethylene copolymerized with one or more monomers, such as vinyl acetate, butyl acrylate, methyl acrylate, acrylic acid, ethyl acrylate, or a C₃-C₁₀ α-olefin. The LDPE is preferably ethylene homopolymer with a density of about 0.923 g/cm³ and a melt index of about 0.6-9.0 g/10 min. An alternative embodiment of the stretch film contains an LDPE that is a copolymer. Methods for manufacturing LDPE are disclosed in The Wiley Encyclopedia of Packaging Technology, Aaron L. Brody et al. eds., 2nd Ed. 1997, pp. 753-754, and in U.S. Pat. No. 5,399,426, which are incorporated by reference herein.

The LLDPE used in either the cling layer or the core layer is ethylene copolymerized with one or more C₃-C₁₀ α-olefins, with a density ranging from about 0.900 to about 0.940 g/cm³, more preferably from about 0.910 to about 0.930 g/cm³, and a melt index ranging from about 1.0 to about 20.0 g/10 min., more preferably from about 1.5 to about 6.0 g/10 min. Similar to the ULDPE discussed above, LLDPE used in the films of the present invention is preferably ethylene copolymerized with one monomer of 1-butene, 1-hexene, 4-methyl-l-pentene, or 1-octene. LLDPE may alternatively contain more than one comonomer selected from a-olefins such as 1-butene, 1-hexene, 4-methyl-1-pentene, and/or 1-octene. The core layer preferably contains about 97% to about 99.9% of LLDPE that is ethylene copolymerized with a C8 α-olefin, with a density of 0.917 g/cm³ and a melt index of 4.0 g/10 min.

LLDPE is manufactured by the same processes discussed above in connection with ULDPE. For example, ethylene may be copolymerized using various catalysts such as a Ziegler-Natta catalyst or a metallocene catalyst, or a combination of these catalysts. LLDPE has a higher density than ULDPE and plastomer because it is copolymerized with a lower concentration of comonomer than ULDPE or plastomer.

The density ranges and melt indexes as disclosed herein for ULDPE and LLDPE and for plastomer and ULDPE partially overlap. However, these polymers may be further distinguished by crystallinity, measured as melt point. A ULDPE with the same melt index and density of LLDPE will have a lower melt point than LLDPE as disclosed herein. Similarly, a plastomer with the same density and melt index of a ULDPE, will have a lower melt point than ULDPE.

The film of the present invention further includes a non-cling or “slip” layer that preferably makes up about 5-40% by weight of the total film thickness, more preferably from about 15-30%, and most preferably about 20%. The non-cling layer is preferably composed of a mixture of homopolymer or copolymer propylene and polystyrene. The polypropylene non-cling layer may have a density ranging from about 0.890 g/cm³ to about 0.910 g/cm³, more preferably from about 0.895 g/cm³ to about 0.905 g/cm³ and a melt flow rate from about 2.0 g/10 min to about 40.0 g/10 min. The polypropylene may be a homopolymer or may be the product of propylene copolymerization with a comonomer, preferably ethylene. Alternatively, propylene may be copolymerized with another comonomer, such as a C₃-C₁₀ α-olefin. The polypropylene of the present invention is preferably a copolymer of propylene and ethylene 4, the ethylene content ranging from 0 to about 10% by weight of the copolymer, more preferably in an amount ranging from about 2% to about 6% by weight. A preferred embodiment has a propylene copolymerized with ethylene, the ethylene content ranging from about 2% to about 4% by weight known as random copolymer polypropylene. The random copolymer of polypropylene may have a density of about 0.905 g/cm³ and a melt flow rate of about 7.0 g/10 min. The method for measuring polypropylene melt flow rate is disclosed in The Wiley Encyclopedia of Packaging Technology (Aaron L. Brody et al. eds., 2nd Ed. 1997) p. 677 and methods for manufacturing polypropylene are disclosed in Kirk-Othmer Concise Encyclopedia of Chemical Technology pp. 1420-21 (Jacqueline I. Kroschwitz et al. eds., 4th Ed. 1999), which is incorporated herein by reference. In the preferred multilayer stretch film, the non-cling layer is preferably composed of from about 40-80% by weight of homopolymer polypropylene, from about 15-59% by weight of random copolymer polypropylene, and from about 1-5% by weight of polystyrene.

The amount of each polymer included in the inventive films is selected to create an optimal balance of several physical properties. The stretch films of the present invention balance increased load and holding containment and stretch with clarity, puncture resistance and resistance to tear propagation. The inventive stretch films have a core layer that includes linear low density polyethylene with a small percentage of low density polyethylene. The low density polyethylene provides good load containment, stretch and necked-in width. The amount of low density polyethylene is a low percentage, in the range of 0.01% to about 3%, because at higher percentages, low density polyethylene reduces the film's puncture resistance, resistance to tear propagation and clarity. Therefore, the stretch film of the present invention optimizes load containment, stretch, puncture resistance and clarity by incorporating a small percentage of low density polyethylene.

One skilled in the art will recognize that the overall thickness of the stretch film can be varied depending on the particular end use for which the film is manufactured. The films of the present invention have a thickness that is generally in the range of typical thickness for stretch wrap films, but may be easily adjusted by one skilled in the art to fit the desired end use. It has been discovered that the greatest benefits from the balance of properties of the present invention are found in gauges ranging from about 40 gauge to about 500 gauge. Even more beneficial are the properties of the film of the present invention at gauges ranging from about 60 gauge to about 250 gauge. At these gauge ranges, it has been discovered that the film performs better than prior art films. Therefore, the films of the present invention preferably have a thickness ranging from about 0.4 mils to about 5.0 mils and more preferably from about 0.6 mils to about 2.5 mils.

It will be appreciated by those skilled in the art that additives may be added to any of the film layers in order to improve certain characteristics of the particular layer or to meet special requirements of specific applications. From about 0-99% by weight of the preferred first layer, second layer, third layer or other individual layer, more preferably from about 0-10%, and most preferably from about 0.1-1.5%, of one or more additives may be added. Preferred additives include color concentrates, slip agents, antiblocking agents, fillers, and specialty additives for specific applications.

A color concentrate maybe added to the layer to yield a colored layer, an opaque layer, or a translucent layer. Preferred color concentrates include color formulations including black, especially carbon black, white, and other colors suitable for agricultural films such as those manufactured by Ampacet Corporation (Tarrytown, N.Y.). Preferred color concentrates include Ampacet® white UV PE masterbatch, the carrier resin of which being a LDPE having a melt index of 12 g/10 min at 190° C. and a density of 0.916 gm/cc and the concentrate of which has a nominal specific gravity of 1.79, a melt index of 2-8 g/10 min at 190° C. and a pigment composed of 65% TiO₂. Another preferred color concentrate includes Ampacet® black PE masterbatch, the carrier resin of which being a LLDPE having a nominal melt index of 20 g/10 min at 190° C. and a density of 0.92 gm/cc. The concentrate has a nominal specific gravity of 1.15, a melt index of <6 g/10 min at 190° C., and a pigment composed of 40% carbon black. Another preferred color concentrate includes Ampacet® black UV PE masterbatch, the carrier resin of which being a LDPE or LLDPE having a nominal melt index of 24 g/10 min at 190° C. and a density of 0.92 gm/cc. The concentrate has a specific gravity of 1.14, a melt index of 4-10 gm/cc at 190° C., and contains about 40% carbon black. It will be appreciated by those skilled in the art that any suitable color concentrate may be used in order to satisfy particular requirements for a film being produced in accordance with the present invention.

Preferred slip agents include stearamide, oleamide, and erucamide. A particularly preferred slip agent is Ampacet® Slip PE masterbatch having a LDPE carrier resin with an 8 g/10 min melt index at 190 and a density of 0.918 gm/cc. The slip agent's concentrate has a nominal specific gravity of 0.92, a nominal melt index of 10-16 g/10 min and contains 5% erucamide. Slip agents may be used alone or in combination with antiblocking agents. A preferred slip/antiblock combination is Ampacet® Slip AB PE masterbatch having a LDPE carrier resin with an 8 g/10 min melt index at 190° C. and a density of 0.92 gm/cc. The slip agent's concentrate has a nominal specific gravity of 0.93, a nominal melt index of 5-14 g/10 min at 190° C. and contains 2% slip agent and 2% antiblock. An antiblocking agent alone may also be added to a layer. Preferred antiblocking agents include organic polymers such as polyamides, polycarbonates, polyesters.

The present invention is further illustrated by the following examples, which are not to be construed in anyway as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

A multilayer stretch film with superior cling and abrasion resistance having a total film thickness of about 1.0 mils was produced using the formula set forth in Table 1 wherein layer A is the slip or non-cling layer, layer B is the core layer, and layer C is the cling layer.

TABLE 1
Formulation 1.

| Layer | Ratio | Wt % | Type | Mfr | MFR | MI | Density |
|---|---|---|---|---|---|---|---|
| A | 20% | 60.0 | Homopolymer | Dow | 8.7 | | |
| | | | Polypropylene | | | | |
| | | 38.0 | Random | Dow | 7.0 | | |
| | | | Copolymer | | | | |
| | | | Polypropylene | | | | |
| | | 2.0 | Polystyrene | Dow | 1.5 | | |
| B | 70% | 95.0 | LLDPE | Voridian | | 4 | 0.917 |
| | | 5.0 | LDPE | Dow | | 0.6 | 0.923 |
| C | 10% | 100.0 | Plastomer | Dow | | 3.0 | 0.875 |

### Example 2

A multilayer stretch film with superior cling and abrasion resistance having a total film thickness of about 2.0 mils is produced using the formula set forth in Table 1 wherein layer A is the slip or non-cling layer, layer B is the core layer, and layer C is the cling layer.

TABLE 2
Formulation 2.

| Layer | Ratio | Wt % | Type | Mfr | MFR | MI | Density |
|---|---|---|---|---|---|---|---|
| A | 20% | 60.0 | Homopolymer | Dow | 8.7 | | |
| | | | Polypropylene | | | | |
| | | 38.0 | Random | Dow | 7.0 | | |
| | | | Copolymer | | | | |
| | | | Polypropylene | | | | |
| | | 2.0 | Polystyrene | Dow | 1.5 | | |
| B | 70% | 95.0 | LLDPE | Voridian | | 4.0 | 0.917 |
| | | 5.0 | LDPE | Dow | | 0.6 | 0.923 |
| C | 10% | 80.0 | Plastomer | Dow | | 3.0 | 0.875 |
| | | 20.0 | ULDPE | Dow | | 5.0 | 0.900 |

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. It is intended that the scope of the invention not be limited by the specification, but be defined by the claims set forth below.

We claim:

1. A multilayer stretch film comprising:
at least one first layer comprising polypropylene and polystyrene;
at least one second layer comprising at least one polyolefin polymer; and
at least one third layer comprising a polymer selected from the group consisting of ultra low density polyethylene, very low density polyethylene, plastomer, polyisobutylene, linear low density polyethylene, and mixtures thereof.

2. The film of claim 1 wherein said first layer comprises from about 15-99% by weight of said polypropylene.

3. The film of claim 1 wherein said polypropylene is selected from the group consisting of homopolymer polypropylene, copolymer polypropylene, random copolymer polypropylene, and mixtures thereof.

4. The film of claim 3 wherein said first layer comprises from about 40-80% by weight of said homopolymer polypropylene.

5. The film of claim 4 wherein said first layer further comprises from about 15-59% by weight of said random copolymer polypropylene.

6. The film of claim 5 wherein said first layer further comprises from about 1-5% by weight of said polystyrene.

7. The film of claim 1, said first layer further comprising from about 0-99% by weight of at least one additive is selected from the group consisting of color concentrates, slip agents, fillers, specialty additives, and antiblocking agents.

8. The film of claim 1 wherein said polyolefin polymer is selected from the group consisting of linear low density polyethylene, low density polyethylene, and mixtures thereof.

9. The film of claim 8 wherein said second layer comprises from about 97-99.9% by weight of said linear low density polyethylene.

10. The film of claim 8 wherein said second layer comprises less than about 3.0% by weight of said low density polyethylene.

11. The film of claim 1 wherein said second layer comprises from about 1-100% by weight of said at least one polyolefin polymer.

12. The film of claim 11, said second layer further comprising from about 0-99% by weight of at least one additive selected from the group consisting of color concentrates, slip agents, fillers, specialty additives, and antiblocking agents.

13. The film of claim 1, said third layer comprising from about 0-100% by weight of said ultra low density polyethylene.

14. The film of claim 13, said third layer comprising from about 10-40% by weight of said ultra low density polyethylene.

15. The film of claim 1, said third layer comprising from about 0-100% by weight of said plastomer.

16. The film of claim 16, said third layer comprising from about 70-100% by weight of said plastomer.

17. The film of claim 1, said third layer further comprising from about 0-99% by weight of at least one additive selected from the group consisting of color concentrates, slip agents, antiblocking agents, fillers, and specialty additives.

18. The film of claim 1 wherein said film has a gauge of from about 40-500.

19. The film of claim 1 wherein said film has a gauge of from about 60-250.

20. The film of claim 1 wherein said first layer comprises from about 5-40% by weight of said film.

21. The film of claim 1 wherein said second layer comprises from about 50-90% by weight of said film.

22. The film of claim 1 wherein said third layer comprises from about 5-40% by weight of said film.

23. The film of claim 1 wherein said first layer has non-cling properties.

24. The film of claim 1 wherein said third layer has cling properties.

25. The film of claim 1 wherein said second layer is disposed between said first layer and said third layer.

26. The film of claim 1 further comprising additional layers.

27. The film of claim 26, said film having from about 3-12 layers.
